(19) United States
(12) Patent Application Publication
(10) Pub. No.: US 2016/0077880 A1
(43) Pub. Date: Mar. 17, 2016

(54) Portfolio Generation Based on a Dynamic Allocation of Resources

(71) Applicant: HEWLETT-PACKARD DEVELOPMENT COMPANY, L.P., Houston, TX (US)

(72) Inventors: Cipriano (Pano) A Santos, Palo Alto, CA (US); Ivan Adrian Lopez-Sanchez, Mexico City (MX)

(21) Appl. No.: 14/485,339

(22) Filed: Sep. 12, 2014

(51) Int. Cl. G06F 9/50; G06F 3/0484; G06F 9/48

(52) U.S. Cl. CPC G06F 9/5011; G06F 9/4881; G06F 3/0484

(57) ABSTRACT

Portfolio generation based on a dynamic allocation of resources is disclosed. One example is a system including a data processor, a resource allocator, and a portfolio planner. The data processor accesses resource allocation data including a plurality of projects, a portfolio shaping preference, a plurality of constraints and a plurality of objectives, and activates, based on the portfolio shaping preference, a sub-plurality of the plurality of constraints and a sub-plurality of the plurality of objectives. The resource allocator generates at least one project portfolio based on the sub-plurality of constraints and the sub-plurality of objectives, wherein the at least one project portfolio includes a sub-plurality of the plurality of projects, and is based on a dynamic allocation of the resource allocation data. The portfolio planner schedules the sub-plurality of the plurality of projects, and provides the at least one project portfolio to a computing device via a graphical user interface.

### BACKGROUND

A portfolio of projects may need to be generated based on a dynamic allocation of available resources. The resources may include temporal, labor, and economic constraints. Generally, several hundreds of large and complex projects may need to be planned and managed, and may typically involve thousands of employees and contractors. Resources available to plan and manage such projects may need to be dynamically adaptable based on several factors, such as changing business priorities, unstable economic conditions, changing labor capacity, changing budgetary constraints, and so forth.

### BRIEF DESCRIPTION OF THE DRAWINGS

FIG. 1A is a functional block diagram illustrating one example of a system for project portfolio generation based on a dynamic allocation of resources.

FIG. 1B is a functional block diagram illustrating another example of a system for project portfolio generation based on a dynamic allocation of resources.

FIG. 2 is a timeline diagram illustrating one example of a time-phased project benefit model.

FIG. 3 is a block diagram illustrating one example of a processing system for implementing the system for project portfolio generation based on a dynamic allocation of resources.

FIG. 4 is a block diagram illustrating one example of a computer readable medium for project portfolio generation based on a dynamic allocation of resources.

FIG. 5 is a flow diagram illustrating one example of a method for project portfolio generation based on a dynamic allocation of resources.

### DETAILED DESCRIPTION

Businesses are frequently faced with a task of prioritizing, selecting and assigning multiple projects, while optimizing utilization of available resources, such as, human resources, budgetary constraints, and time constraints. Generally, several hundreds of large and complex projects may need to be planned and managed, and may typically involve thousands of employees and contractors. Such optimization may need to be performed under constantly changing constraints. The changing constraints reflect the dynamic consumption of resources (budget and labor) over time. For example during the ramp-up phase of a project architects, business consultants, and certain developers and testers are required. During the development phase mostly developers are required. Finally, at the ramp-down phase of the project, testers and business consultants are required.

Business priorities may be constantly shifting to meet changing market conditions. Some proposed projects may have clear tangible financial benefits, including lowered costs and/or increased revenue. Other projects may not have a direct dollar impact but may still be very important (e.g. improving customer satisfaction, addressing legal and/or regulatory requirements, or investing in R&D that could have huge future payoffs). Some projects may have a clearly defined business sponsor ranking that may or may not correspond to a quantifiable “benefit” valuation. Various weighting schemes may be utilized to assign value or scoring to projects, based on a range of characteristics such as return of investment (“ROI”), strategic alignment, or project duration. Additionally, there may be a wide range of practical and/or political implications with regards to trade-offs and choices that must be made when selecting any given project portfolio.

Many factors may be considered during portfolio planning, such as resourcing, available funding, corporate priorities, sponsor attitudes, and/or business impact. An inability to efficiently optimize over such factors may translate into millions of dollars of lost opportunity. Existing practices to prioritize, select and assign project portfolios are typically manual, and therefore cumbersome, requiring ‘Planners’ to navigate through multiple spreadsheets—with potentially inconsistent data.

Generally, optimization of project portfolios may be difficult since available resources may be scarce, there may be a large number of combinations of projects to select and schedule optimally within the limited available resources. Additionally, there may be several conflicting objectives to be considered when selecting a portfolio. Accordingly, there may be a need to optimize the trade-offs between these conflicting objectives. Generally, optimization of a project portfolio may be a manual and time consuming process, with a lot of room for sub-optimal results leading to waste and delays in projects. Many potentially useful portfolio scenarios may not be considered due to the enormous complexity of manipulating dozens or hundreds of projects involved, along with all their interlocking dependencies and resource requirements. With an increasing demand to increase responsiveness to changing business needs, time may be of essence to comprehensively examine all the possibilities. A lack of analytical methods may exacerbate such problems, may further prevent optimization, and may have a negative impact on a business in terms of lowering productivity and missing windows of opportunity for deploying high impact projects.

As described in various examples herein, project portfolio generation based on a dynamic allocation of resources is disclosed. These are iterative techniques for selecting a portfolio that better optimizes a portfolio value for the portfolio in consideration of potentially conflicting and competing objectives, while still satisfying constraints. Analytical methods for selection and scheduling of a project portfolio are disclosed, such that the trade-offs among various conflicting objectives are optimized, while multiple constraints are satisfied. These constraints may include, for example, headcount (differentiated by skills and role), budget (differentiated by various types of costs such as, for example, IT labor, business labor, and non-labor), project precedence, project initiation and/or completion date windows, and portfolio shaping preferences.

As described herein, project portfolio generation based on a dynamic allocation of resources is disclosed. One example is a system including a data processor, a resource allocator, and a portfolio planner. The data processor accesses resource allocation data including a plurality of projects, a portfolio shaping preference, a plurality of constraints and a plurality of objectives, wherein the resource allocation data is indicative of resources that are potentially available for allocation to the plurality of projects, and activates, based on the portfolio shaping preference, a sub-plurality of the plurality of constraints and a sub-plurality of the plurality of objectives. The resource allocator generates at least one project portfolio based on the sub-plurality of constraints and the sub-plurality of objectives, wherein the at least one project portfolio includes a sub-plurality of the plurality of projects, and is based on a dynamic allocation of the resource allocation data. The portfolio planner schedules the sub-plurality of the plurality of projects, and provides the at least one project portfolio to a computing device via a graphical user interface.

This process may be continued iteratively until a desired portfolio is selected, where portfolios are regenerated using the first and/or second optimization models after, for instance, modifying the constraints, the bounds, and/or the prioritization of the objectives.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

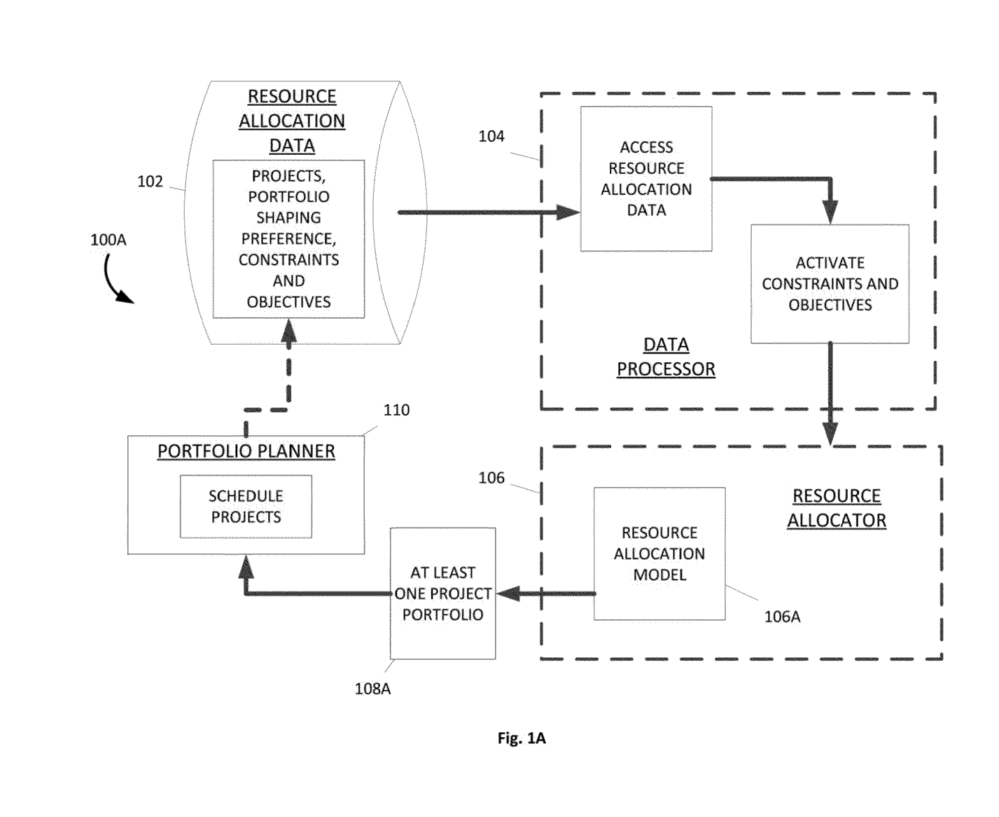

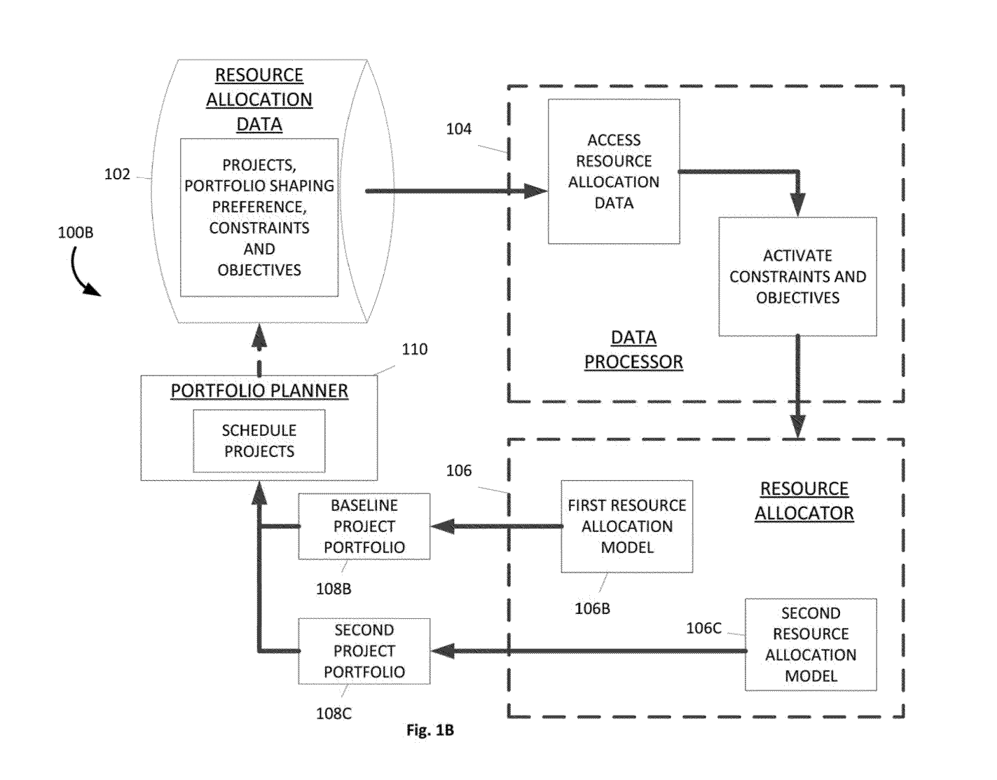

FIG. 1A is a functional block diagram illustrating one example of a system 100A for project portfolio generation based on a dynamic allocation of resources. System 100A accesses resource allocation data, the resource allocation data including a plurality of projects, a portfolio shaping preference, a plurality of constraints and a plurality of objectives, wherein the resource allocation data is indicative of resources that are potentially available for allocation to the plurality of projects. Based on the resource allocation data, system 100A activates a sub-plurality of the plurality of constraints and a sub-plurality of the plurality of objectives. System 100A generates at least one project portfolio at least one project portfolio based on the sub-plurality of constraints and the sub-plurality of objectives, wherein the at least one project portfolio includes a sub-plurality of the plurality of projects, and is based on a dynamic allocation of the resource allocation data. System 100A schedule the sub-plurality of the plurality of projects, and provides the at least one project portfolio to a computing device via a graphical user interface.

System 100A includes a data processor 104 to access resource allocation data 102. The resource allocation data 102 constitutes a scenario that a decision maker may want to analyze and optimize. Resource allocation data 102 includes a plurality of projects, a portfolio shaping preference, a plurality of constraints and a plurality of objectives, wherein the resource allocation data is indicative of resources that are potentially available for allocation to the plurality of projects. The portfolio shaping preference is a portfolio shaping preference that may be utilized to generate the at least one project portfolio via a resource allocation model. The portfolio shaping preference may include logic and/or steps required before, during, and/or after the resource allocation model is applied. For example, the portfolio shaping preference may perform a time window estimation before the resource allocation model is applied. As another example, the portfolio shaping preference may perform capacity shortage detection during the application of the resource allocation model. Also, for example, the portfolio shaping preference may include provision of suggestions to correct any detected capacity shortage after the application of the resource allocation model. In one example, the portfolio shaping preference may include at least one of a Pareto optimization model (“POM”), a multiple-criteria ranking optimization model (“MCRM”), and a basic optimization model (“BOM”). These portfolio shaping preferences are described in further detail herein. The resource allocation model is the underlying mathematical model that generates feasible solutions by optimizing at least one objective of the plurality of objectives, subject to at least one constraint of the plurality of constraints.

In one example, resource allocation data 102 includes structural data and configurable data. In one example, structural data may include at least one of:
A list of candidate projects
A list of organizations involved in the candidate projects
A list of Investment Areas
A list of Executive Sponsors
A list of start time periods in a planning horizon
A list of objectives that may be used to optimize a portfolio
A table of projects belonging to each organization
A table of projects belonging to each Investment Area
A table of projects belonging to each Executive Sponsor
A table of project pairs that have temporal relationship, i.e. precedence or minimum time lag; and value of minimum time lag. This table may help define constraints such as, for example, Project P2 may start after completing 80% of project P1.
A table with an earliest time period a project may start, latest time period a project may be completed, and a duration of a project (i.e. number of time periods required to complete a project).
A table with a set of subsets of projects reflecting all-or-nothing constraints. That is, the projects within each subset must either be all selected or none of them may be selected. This type of constraint may allow specifying Programs (subset of projects) where a Program may be selected if and only if all projects of the Program are selected.
A table with a set of subsets of projects reflecting exclusive-or constraints. That is, at most one of the projects within each subset may be selected. This type of constraint may allow specifying alternatives for deploying the same project in terms of different technologies used, full-time-equivalent (“FTE”) capabilities and roles, and cost structures.
A table with the roles and capabilities of the workforce required and the available workforce.
A table defining the FTE requirements at each time period during the duration of the project, by capability and role.
A table defining the FTE capacity available at each time period during a planning horizon, by capability and role.
A table with the different types of budgets and costs.
A table defining the cost type incurred at each time period during the duration of the project.
A table defining the objectives, the project valuation respect to each objective at completion of project and at time periods before or after completion of project (these time periods are called offset periods).

In one example, the configurable data may include:
A list of projects that must be selected by the optimal portfolio regardless of objective function or constraints in a project portfolio optimization model (“PPO”).
A list of projects that must not be selected by the optimal portfolio regardless of objective function or constraints in the PPO model.
A table of projects having a fixed schedule (i.e., must start at a certain time period during the planning horizon). An option may be to have a flexible schedule where a project may start at a proposed start date or later.
A table defining the span of time periods in the planning horizon that a budget may be consumed. The budget may be available for consumption at the beginning of the first time period in the span of periods of the budget.
A table defining the amount of budget type available at its span of time periods.
A table with configuration parameters such as length of start period planning horizon, and discount factor used to weight project valuation at project completion and offset periods.
A table containing information about the Portfolio shaping preference to be used to optimize a project portfolio.
A table with minimum and/or maximum percentage of number, FTE and/or cost projects in Investment Area (e.g., organization, and/or Executive Sponsor) that must be satisfied by selected projects in an optimal portfolio. This table may help defining constraints such as, for example, “ensure that at least 20% of the FTE of selected projects corresponds to Research and Development (“R&D”) investment area.”

In one example, the plurality of constraints may include a soft constraint that may be violated. The soft constraint may include, for example, Project Portfolio Mix constraints that may enable the decision maker to shape an optimized portfolio by, for example, defining upper and lower bounds on a percentage (respect to the overall projects selected in a portfolio) of number (cost, or FTE) of selected projects in a particular project category (e.g. investment area, IT-organization, Executive Sponsor). For example, the decision maker may want to ensure that at least 20% of the FTE of selected projects corresponds to R&D investment area, and/or wants to ensure that at least 10% of the selected projects corresponds to Human Resources (“HR”) Senior Vice President Executive sponsor, and/or wants to ensure that at most 30% of the quarterly budget allocated to selected projects corresponds to a particular organization. Accordingly, the decision maker may create a portfolio mix tailored to business requirements.

As another example, the soft constraint may include, for example, Projects Cost Smoothing constraints that may allow the decision maker to smooth a difference between project costs scheduled at some month and project costs scheduled at a following month. When such constraints are applied to labor project costs, they may help ensure appropriate labor utilization.

Also, for example, the soft constraint may include Budget constraints that may ensure that the consumption of budget by the projects selected in the portfolio do not exceed the Budget limits specified. Budget may be differentiated by various types of costs such as, for example, in Information Technology (“IT”) related projects, Labor IT costs, Non-Labor IT costs, Total IT costs, Business costs, and Total costs. As another example, the soft constraint may include Labor Capacity constraints that may ensure that the consumption of headcount by the projects selected in the portfolio do not exceed the Labor Capacity limits specified. FTE may be differentiated by skills and role.

In one example, system 100A may detect an infeasibility of the soft constraint. In one example, system 100A may correct the detected infeasibility of the soft constraint. For example, system 100A may detect and correct budget shortages by attempting to optimize portfolios based on the budget constraints in the resource allocation data 102. As another example, system 100A may detect and correct labor shortages by attempting to optimize portfolios based on the Labor Capacity constraints in the resource allocation data 102.

In one example, the plurality of constraints includes a hard constraint that may not be violated. The hard constraint may include, for example, Project Release and Due dates constraints that may ensure that if the project is selected, the start time of the project will be between the time window defined by the Release and Due dates.

Also, for example, the hard constraint may include project alternatives such as Exclusive Or (“XOR”) constraints that may ensure that at most one project among a set of projects is selected. For example, there may be several alternative options for deploying the same project, and the XOR constraint may be defined over this set of options to enforce selection of at most one of these options. Alternative options of the same project may be defined in terms of FTE requirements, alternative cost structures, time windows of opportunity, and so forth.

In one example, system 100A may detect and correct FTE capacity shortages by attempting to optimize portfolios based on the labor capacity constraints, the XOR constraints, and so forth. In one example, a set of alternative options may be defined to deploy a project, and enforce selection of at most one of such alternative options.

As another example, the hard constraint may include If and Only If (“IFF”) constraints that may ensure that all projects in a Program of related projects are selected or none are selected.

Also, for example, the hard constraint may include decision maker project preference constraints that may ensure that regardless of the optimization objective, either a project is always selected or the project is never selected. Additionally, the Decision Maker may stipulate when a project must start when selected.

As another example, the hard constraint may include Project Temporal constraints ensure that may ensure that a set of related projects follow minimum time lags and/or precedence relations if selected. For example, Project P2 may start after completing 80% of project P1.

The plurality of constraints may be determined based on a type of business, a type of project, and so forth. For clarity of exposition, the following collections of objects may he identified:
[symbol] : set of candidate projects to be considered
U: set of projects directly selected by the portfolio manager
V: set of projects that cannot be selected in the portfolio; projects in this set are removed from further consideration during optimization
F: set of projects having a fixed schedule (starting and finishing times)
G: set of IT organizations
A: set of investment areas
S: set of executive sponsors
P_{g}: set of projects belong to IT organization g ∈ G
Pₛ: set of projects belong to executive sponsor s ∈ S
Pₐ: set of projects belonging to investment area a ∈ A.
E: set of project pairs that have temporal relationship, i.e. precedence or minimum time lag
M: set of all-or-nothing constraint sets. The projects within each set m ⊂ M must either be all selected or none of them should be selected.
N: set of exclusive-or (XOR) constraint sets. At most one of the projects within each set n ⊂ N may be selected.
R: set of roles arid capabilities of FTE
B: set of different types of budgets
T: set of all time periods in the planning horizon
Q: set of budget periods during the planning horizon
T_{q}: set of time periods in budget period q ∈ Q
O: set of objectives to be optimized, e.g. Business Indices, Customer Satisfaction, Strategic Alignment, etc.

Example parameters that may be utilized in the plurality of constraints and the plurality of objectives may be enumerated as follows:
α: a positive discounting factor
θ_{g1}: minimum percentage of projects in IT organization g ∈ G in terms of project counts. Its counterpart of maximum percentage may be defined as θ̅_{g1}.
θ_{g2}: minimum percentage of projects in IT organization g ∈ G in terms of FTE headcounts. Its counterpart of maximum percentage may be defined as θ̅_{g2}.
θ_{g3}: minimum percentage of projects in IT organization g ∈ G in terms of cost of budget. Its counterpart of maximum percentage may be defined as θ̅_{g3}.
θₛ₁: minimum percentage of projects belonging to executive sponsor s ∈ S in terms of project counts. Its counterpart of maximum percentage may he defined as θ̅ₛ₁.
θₛ₂: minimum percentage of projects belonging to executive sponsor s ∈ S in terms of FTE headcounts. Its counterpart of maximum percentage may be defined as θ̅ₛ₂.
θₛ₃: minimum percentage of projects belonging to executive sponsor s ∈ S in terms of cost of budget. Its counterpart of maximum percentage may be defined as θ̅ₛ₃.
θₐ₁: minimum percentage of projects in investment area a ∈ A in terms of project counts. Its counterpart of maximum percentage may be defined as θ̅ₐ₁.
θₐ₂: minimum percentage of projects in investment area a ∈ A in terms of FTE headcounts. Its counterpart of maximum percentage may be defined as θ̅ₐ₂.
θₐ₃: minimum percentage of projects in investment area a ∈ A in terms of cost of budget. Its counterpart of maximum percentage may be defined as θ̅ₐ₃.
dₚ: duration of project p ∈ [symbol]
δ_{pp′}: minimum time lag between a pair of projects (p,p′) ∈ E, i.e. project p cannot start until at least δ_{pp′}, time units after p′. This is a hard constraint.
λₚ: release date of project p ∈ [symbol]
εₚ: due date of project p ∈ [symbol]
Kᵣₜ: headcounts of FTE with role/capability r ∈ R available in time period t ∈ T
K_{bq}: amount of available budget of type b ∈ B in budget period q ∈ Q
uₚᵣₜ: units of FTE with role r ∈ R required by project p in the t^{th} period of project p's duration
γ_{pbt}: cost of type b ∈ B budget by project p in the t^{th} period of project p's duration
ρₚ: priority ranking of project p. A low ranking value means higher priority.
φₚₒ: score of project p in objective o ∈ O
ωₚ: a weighted score of project p.

Given a release date λₚ, duration dₚ and due date εₚ of a project p ∈ [symbol] , plus the minimum time lag δ_{pp′} between a pair of projects (p,p′) ∈ E, a temporal analysis may be performed to obtain time windows of each project. That is, ESₚ-earliest start, EFₚ-earliest finish, LSₚ-latest start, LFₚ-latest finish of project p.

Example decision variables that may be utilized in the plurality of constraints and the plurality of objectives may be enumerated as follows:
yₚ=1 binary selection decision variable. It equals to 1 if project p ∈ [symbol] is selected in the portfolio; and 0 otherwise.
xₚₜ=1 time indexed binary decision variable. It equals to 1 if project p ∈ [symbol] starts at time period t; and 0 otherwise.
zₚₜ=1 time indexed binary decision variable. It equals to 1 if project p ∈ [symbol] finishes at time period t; and 0 otherwise.
Auxiliary variables to capture the absolute value of the difference of projects costs schedule at month t and month t+1
δ_{abqt}⁺≧0
δ_{abqt}⁻≧0

In one example, the plurality of constraints includes Constraint (2-1) that allows the decision-maker to directly select projects; while Constraint (2-2) makes it possible to directly de-select projects.

yₚ=1 ∀p ∈ U (2-1)

yₚ=0 ∀p ∈ V (2-2)

The plurality of constraints (3) through (5) shape the mix of projects in terms of organizations, executive sponsors and investment areas. Specifically, Constraint (3-1) enforces the number of projects in IT organization g to be at least θ_{g1} of all the selected projects. Constraint (3-2) states that the percentage of headcount of FTE with role/capability r required by all projects in IT organization g must be no less than θ_{g2} of that required by all the selected projects. Constraint (3-3) ensures that the percentage of budget type b required by all projects in g must be no less than θ_{g3} of that required by all the selected projects. Constraints (4-1) through (4-3) specify these constraints in a similar way with respect to executive sponsors; Constraints (5-1) through (5-3) are for investment areas. The counterparts of these constraints enforcing maximum percentage may be expressed using the upper bound percentages θ̅_{g1}, θ̅_{g2}, θ̅_{g3}, θ̅ₛ₁, θ̅ₛ₂, θ̅ₛ₃, θ̅ₐ₁, θ̅ₐ₂, θ̅ₐ₃.

Σ_{p∈P}_{_{g}} yₚ≧θ_{g1}· [symbol] yₚ ∀g ∈ G (3-1)

Σ_{p∈P}_{_{g}}(yₚ·Σₜ₌₀^{d}^{ₚ}uₚᵣₜ)≧θ_{g2}· [symbol] (yₚ·Σₜ₌₀^{d}^{ₚ}uₚᵣₜ) ∀g ∈ G, r ∈ R (3-2)

Σ_{p∈P}_{_{g}}(yₚ·Σₜ₌₀^{d}^{ₚ}γ_{pbt})≧θ_{g3}· [symbol] (yₚ·Σₜ₌₀^{d}^{ₚ}γ_{pbt}) ∀g ∈ G, b ∈ B (3-3)

Σ_{p∈P}_{ₛ} yₚ≧θₛ₁· [symbol] yₚ ∀s ∈ S (4-1)

Σ_{p∈P}_{ₛ}(yₚ·Σₜ₌₀^{d}^{ₚ}uₚᵣₜ)≧θₛ₂· [symbol] (yₚ·Σₜ₌₀^{d}^{ₚ}uₚᵣₜ) ∀s ∈ S, r ∈ R (4-2)

Σ_{p∈P}_{ₛ}(yₚ·Σₜ₌₀^{d}^{ₚ}γ_{pbt})≧θₛ₃·z,36 (yₚ·Σₜ₌₀^{d}^{ₚ}γ_{pbt}) ∀s ∈ S, b ∈ B (4-3)

Σ_{p∈P}_{ₐ} yₚ≧θₐ₁· [symbol] yₚ ∀a ∈ A (5-1)

Σ_{p∈P}_{ₐ}(yₚ·Σₜ₌₀^{d}^{ₚ}uₚᵣₜ)≧θₐ₂· [symbol] (yₚ·Σₜ₌₀^{d}^{ₚ}uₚᵣₜ) ∀a ∈ A, r ∈ R (5-2)

Σ_{p∈P}_{ₐ}(yₚ·Σₜ₌₀^{d}^{ₚ}γ_{pbt})≧θₐ₃· [symbol] (yₚ·Σₜ₌₀^{d}^{ₚ}γ_{pbt}) ∀a ∈ A, b ∈ B (5-3)

Constraint (6) models the ail-or-nothing constraint for each set of projects m ∈ M. That is, all the projects in m must be simultaneously selected or none of them is selected.

yₚ=y_{p′} ∀m ⊂ M, p,p′ ∈ m (6)

Constraint (7) enforces the XOR constraint for each set of projects n ∈ N. That is, at most one of the projects in n may be selected. This constraint makes it possible to select different options of the same project. Suppose a project has a set n of different modes (options) to be executed, which may differ in benefit, duration, and resource usage. The decision-maker would like to select a best option among the |n| alternatives. To support such decision, |n| replicates of the same project may be created, with each replicate carrying the data information associated with the option.

Σ_{p∈n}yₚ≦1 ∀n ⊂ N (7)

Constraint (8) schedules the activities of a selected project to start at exactly one time period, i.e. once started an activity cannot be interrupted. This is also known as the non-preemption assumption. This is a hard constraint. This constraint ensures that a project cannot be interrupted after it is begun. When yₚ=0, there is no need to schedule project p (its starting time is fixed to be zero). Likewise, Constraint (8-1) ensures that a project (if selected) ends at exactly one time period.

Σ_{t=ES}_{ₚ}^{LS}^{ₚ}xₚₜ=yₚ ∀p ∈ [symbol] (8)

Σ_{t=EF}_{ₚ}^{LF}^{ₚ}zₚₜ=yₚ ∀p ∈ [symbol] (8-1)

Constraints (9) guarantees the minimum time lag between a pair of projects (p,p′), i.e. project p′ cannot start until at least δ_{pp′}, time units after project p starts, when both p and p′ are selected. This is a hard constraint.

Associated with each Constraint (9) is an if-then type of logical constraint (9-1) implied by (9). That is, when there exists a temporal relationship between a project pair (p,p′) ∈ E, project p′ (the successor) cannot be selected unless project p (the predecessor) is selected. This is a hard constraint.

$$\begin{matrix}{\sum }_{t = {ES}_{{p}^{′}}}^{{LS}_{{p}^{′}}} t \cdot {x}_{{p}^{′} t} + \vert 𝒯 \vert \cdot ( 1 - {y}_{{p}^{′}} ) - {\sum }_{t = {ES}_{p}}^{{LS}_{p}} t \cdot {x}_{pt} \geq ( {d}_{p} + {δ}_{{pp}^{′}} ) \cdot {y}_{p} ∀ ( p , {p}^{′} ) ∈ E & ( 9 ) \\ {y}_{p} \geq {y}_{p}^{′} ∀ ( p , {p}^{′} ) ∈ E & ( 9 \text{-} 1 )\end{matrix}$$

Constraint (10) satisfies the release date (i.e. the earliest possible starting date) of each project. Feasibility may be achieved even if project p is not selected (yₚ=0). For projects with fixed time windows, their starting times may be fixed to be their earliest release dates (Constraint 10-1).

Σ_{t=ES}_{ₚ}^{LS}^{ₚ}t·xₚₜ≧λₚyₚ ∀p ∈ [symbol] (10)

Σ_{t=ES}_{ₚ}^{LS}^{ₚ}t·xₚₜ=λₚyₚ ∀p ∈ [symbol] (10-1)

Constraint (11) enforces the due date of each project if the project is selected.

Σ_{t=ES}_{ₚ}^{LS}^{ₚ}t·xₚₜ+dₚ≦εₚ ∀p ∈ [symbol] (11)

Constraint (12) models the renewable resource (e.g., FTE headcounts) constraint with varying time-dependent capacities. The left-hand-side computes total requirement of renewable resource r by all the active projects in time period t.

Σ_{p∈} [symbol] Σ_{τ=max{ES}_{ₚ}_{,t-d}_{ₚ}_{+1}}^{min{LS}^{ₚ}^{,t}}u_{pr,t-τ}xₚᵣ≦Kᵣₜ ∀r ∈ R, t ∈ T (12)

Constraint (13) computes the finishing time of each project as a function of its starting time and duration.

Σ_{t=EF}_{ₚ}^{LF}^{ₚ}t·zₚₜ=Σ_{t=ES}_{ₚ}^{LS}^{ₚ}(t+dₚ)·xₚₜ ∀p ∈ [symbol] (13)

Constraints (14) through (16) specify the domain of decision variables.

xₚₜ ∈ {0, 1} ∀p ∈ [symbol] , t ∈ {ESₚ, . . . , LSₚ} (14)

yₚ ∈ {0, 1} ∀p ∈ [symbol] , (15)

zₚₜ ∈ {0, 1} ∀p ∈ [symbol] , t ∈ {EFₚ, . . . , LFₚ} (16)

Constraint (17) computes the absolute value of the difference of projects cost scheduled at month t and month t+1, during months within quarter q. The auxiliary variables capture the absolute value of the difference, where δ_{abqt}⁺>0 if the difference is positive and δ_{abqt}⁻>0 if the difference is negative. The following terms may be added to the appropriate objective function in order to allow cost smoothing during portfolio optimization:

PNLTY*(δ_{abqt}⁺+δ_{abqt}⁻)

where PNLTY is an appropriate penalty value for cost smoothing violations.

Σ_{t∈T}_{_{q}}[Σ_{p∈P}Σ_{τ=max{ES}_{ₚ}_{,t-d}_{ₚ}_{}}^{min{LS}^{ₚ}^{,t}}γ_{pb,t-τ}xₚₜ]−[Σ_{p∈P}Σ_{τ=max{ES}_{ₚ}_{,t-d}_{ₚ}_{+1}}^{min{LS}^{ₚ}^{,t}}γ_{pb,t-τ}xₚₜ]=δ_{a,b,q,t}⁺−δ_{a,b,q,t}⁻ ∀a ∈ A, ∀b ∈ B, q ∈ Q (17)

In one example, the plurality of constraints includes a time-phased resource constraint. Instead of getting a benefit (reward, positive cash inflow) at one time point of a project (e.g., the beginning or the finish), time-phased benefit is a more general case where benefit may be gained during project execution based on labor constraints (e.g., differentiated by role and capabilities), and budget constraints (e.g., differentiated by various type of costs such as labor IT costs, non-labor IT costs, business costs, and so forth). This is often the case in real life service project delivery, as well as in other industry domains including construction, production and R&D.

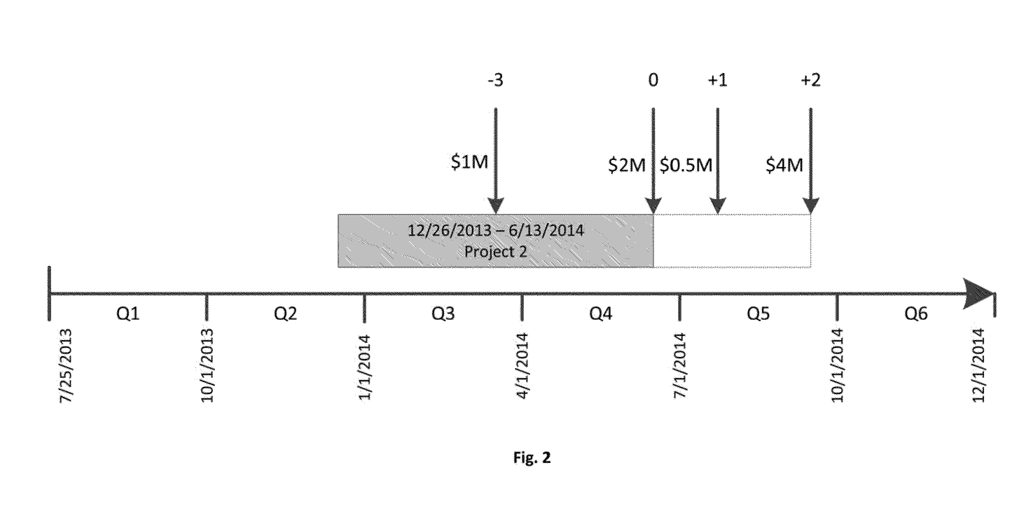

FIG. 2 is a timeline diagram illustrating one example of a time-phased project benefit model. As illustrated, the time-phased project benefits may be estimated or specified by contract in an arbitrary time period defined as an offset from the project completion. An example timeline is illustrated with six quarters. The first quarter (“Q1”) runs from Jul. 25, 2013 to Oct. 1, 2013. The second quarter (“Q2”) runs from Oct. 1, 2013 to Jan. 1, 2014. The third quarter (“Q3”) runs from Jan. 1, 2014 to Apr. 1, 2014. The fourth quarter (“Q4”) runs from Apr. 1, 2014 to Jul. 1, 2014. The fifth quarter (“Q5”) runs from Jul. 1, 2014 to Oct. 1, 2014. The sixth quarter (“Q6”) runs from Oct. 1, 2014 to Dec. 1, 2014. An example project such as Project 2, may start on Dec. 26, 2013, and may be completed on Jun. 13, 2014. Accordingly, project initiation may occur in Q2, and project completion may occur in Q4. In one example, such time-phased project benefits may be modeled to treat each benefit period as a dummy task associated with the project. In this example, the benefit period may correspond to a payment received. Each benefit period may be modeled as a dummy task with zero duration, represented by an arrow pointing downward. In one example, the benefit amount may be represented as a nominal number, for which the corresponding net present value (“NPV”) may be computed for planning purpose. Accordingly, the timing of such dummy tasks may be determined by the model.

For example, a company may receive a nominal payment $1M three months before the project completion, i.e., in Q3. This is illustrated by the numeral “−3”. The company may receive a nominal payment $2M at project completion, i.e., in Q4. This time is illustrated by the numeral “0”. The company may receive a nominal payment $0.5M one month after project completion, i.e., in Q5. This time is illustrated by the numeral “+1”. The company may receive a nominal payment $4M two months after project completion, i.e. in Q5. This time is illustrated by the numeral “+2”.

In one example, to keep the formulation being linear, new time-indexed binary decision variables may be associated with the dummy tasks. For example, let Ψₚ be a set of benefit periods (e.g., dummy tasks) of project p. Each dummy task ψ ∈ Ψₚ may have a benefit of π_{pψ} and an offset of o_{pψ} relative to the completion of project p. In one example, the offset o_{pψ} may be negative, more specifically, o_{pψ} ∈ [−dₚ, +∞). That is, the earliest potential benefit period may be assumed to be the time when the project is started. A binary decision variable z_{pψt} may be defined such that z_{pψt}=1 if and only if dummy task ψ of project p starts at time period t.

Realizing that offset periods relative to project completion times may go beyond a planning horizon T, the planning horizon T may be extended to T′ to cover all possible offset periods. Accordingly, the magnitude of the extended planning horizon, represented by |T′|, may be bounded by the maximum offset

$${max}_{p , ψ} \{ {o}_{p ψ} \}$$

plus |T|. Accordingly,

$${𝒯}^{′} := \{ 0 , 1 , … , \vert 𝒯 \vert , \vert 𝒯 \vert + 1 , … , \vert 𝒯 \vert + {max}_{p , ψ} \{ {o}_{p ψ} \} \} .$$

Based on such factors, the following constraint (18) may compute the start time of a dummy task:

Σt∈T′t·z_{pψt}=Σ_{t=ES}_{ₚ}^{LS}^{ₚ}(t+dₚ+o_{pψ})·xₚₜ ∀p ∈ [symbol] , ψ ∈ Ψₚ (18)

where, for project p ∈ [symbol] , with [symbol] representing a set of candidate projects to be considered, z_{pψt} is the binary decision variable, LSₚ is the latest start, ESₚ is the earliest start, dₚ is a duration, o_{pψ} is the offset, and xₚₜ=1 is time indexed binary decision variable. It equals to 1 if project p ∈ [symbol] starts at time period t; and 0 otherwise.

An objective function maximizing the total time-phased discounted benefit may be expressed as:

Max [symbol] Σ_{ψ∈Ψ}_{ₚ}Σ_{t∈T′}π_{pψ}·z_{pψ}t/(1+α)^{t} (C-1)

where the parameter π_{pψ} may be a project valuation related to any type of objective, not necessarily direct and/or indirect financial benefit, and a is a positive discounting factor.

In one example, the plurality of constraints includes a time-phased budget constraint:

$${\sum }_{t ∈ {T}_{q}} [ {\sum }_{p ∈ P} {\sum }_{τ = max \{ {ES}_{p} , t - {d}_{p} + 1 \}}^{min \{ {LS}_{p} , t \}} {γ}_{pb , t - τ} {x}_{pτ} ] \leq {K}_{bq} ∀ b ∈ ℬ , q ∈ Q \qquad ( 19 )$$

Constraint (19) takes care of the time-phased budget constraints with varying budgeting periods and capacities. Each capacity constraint may be enforced based on arbitrarily defined periods q, each of which contains a predefined set of time periods t. This allows the decision-maker more flexibility in terms of planning and capacity rationalization.

In one example, the time-phased budget constraint is different from a time period scale in a planning horizon. A budgeting period may be flexibly defined to be different from the time period scale considered in the planning horizon. For example, suppose the time period is a month, a budgeting period may be defined as a Quarter (including three months).

In one example, the plurality of objectives includes:

Max [symbol] Σ_{t=EF}_{ₚ}^{LF}^{ₚ}φₚₒzₚₜ/(1+α)^{t} (C-2)

Max [symbol] Σ_{t=EF}_{ₚ}^{LF}^{ₚ}ωₚzₚₜ/(1+α)^{t} (C-3)

Max [symbol] Σ_{t=EF}_{ₚ}^{LF}^{ₚ}ρ′ₚzₚₜ/(1+α)^{t} (C-4)

where EFₚ is the earliest finish, and LFₚ is the latest finish of project p, φₚₒ is a score of project p in objective o ∈ O, zₚₜ=1 is a time indexed binary decision variable, which equals to 1 if project p ∈ [symbol] finishes at time period t; and 0 otherwise. Also, ωₚ is a weighted score of project p. This score may incorporate multiple criteria with their corresponding weights to reflect their relative importance.

In one example, different single objective functions may be utilized. For example, objective function (C-2) maximizes the discounted total portfolio score of the objective o ∈ O, assuming the value of a project (e.g., ranking, project score) is achieved at the completion of the project. Another role of the discounting term α is to avoid unnecessary delayed start of a project with respect to its earliest start time. As another example, a variant objective function (C-3) is to maximize the discounted total weighted score of the portfolio. Also, for example, objective function (C-4) optimizes the discounted total ranking of portfolio. In one example, directly minimizing the total priority ranking may not be the best solution, since an obvious optimal solution would be to not select any projects, which may be associated with an “optimal” ranking of zero. To resolve this issue, the priority ranking may be recoded such that a higher ranking value means higher priority, i.e. p′ₚ=Γ−ρₚ, where Γ is an arbitrary number satisfying Γ≧max{ρₚ, ∀p ∈ [symbol] }+1.

Referring again to FIG. 1A, based on the resource allocation data 102, the data processor 104 activates a sub-plurality of the plurality of constraints and a sub-plurality of the plurality of objectives. In one example, the resource allocation data 102 may be automatically loaded to tables of the PPO model. In one example, the resource allocation data 102, including structural tables and configurable tables, activate the appropriate constraints and objective function of the PPO model.

System 100A includes a resource allocator 106 comprising a resource allocation model 106A to generate at least one project portfolio 108A based on the sub-plurality of constraints and the sub-plurality of objectives, wherein the at least one project portfolio 108A includes a sub-plurality of the plurality of projects, and is based on a dynamic allocation of the resource allocation data. In one example, the resource allocation model 106A generates the at least one project portfolio 108A by optimizing a portfolio value based on the portfolio shaping preference and the sub-plurality of objectives, while satisfying the sub-plurality of constraints. In one example, the portfolio value may be an aggregate of project values included in the portfolio. In one example, the portfolio value may be an aggregate of weighted project values included in the portfolio. In one example, the at least one project portfolio 108A may be based on a dynamic allocation of the resource allocation data to the extent that it cannot be further optimized based on the sub-plurality of objectives and the sub-plurality of constraints. In one example, the resource allocation model 106A optimizes the portfolio value based on objectives under differing bounds of the sub-plurality of objectives while satisfying the sub-plurality of constraints. In one example, the resource allocation model 106A optimizes the portfolio value based on a priority of objectives of the sub-plurality of objectives while satisfying the sub-plurality of constraints.

In one example, the portfolio value that is optimized may be a total net present value (“NPV”) of benefits derived from effectuating the projects of the portfolio, in monetary or other terms. Optimizing the portfolio value may include maximizing the portfolio value, such as maximizing the NPV of the benefits, by optimally scheduling the projects in relation to the resources that the projects use to be completed. Such optimal scheduling is referred to as optimizing the portfolio. Accordingly, there is a portfolio value for each project portfolio that is generated, and a corresponding optimization of each portfolio in terms of how the projects of each portfolio are scheduled with respect to resource utilization.

System 100A includes portfolio planner 110 to schedule the sub-plurality of the plurality of projects, and to provide the at least one project portfolio 108A to a computing device via a graphical user interface.

In one example, the portfolio planner 110 may receive an indication that the at least one project portfolio 108A is not selected. In one example, modified resource allocation data 102 may be accessed via the data processor 104. In one example, the modified resource allocation data may include a modification of a constraint of the sub-plurality of constraints, including an addition or removal of another constraint to the sub-plurality of constraints. In one example, the modified resource allocation data may include a modification of an objective of the sub-plurality of objectives, including an addition or removal of another objective to the sub-plurality of objectives. In one example, the modified resource allocation data may include second project portfolio shaping preference. The data processor 104 accesses the modified resource allocation data, and the resource allocator 106 generates a second project portfolio based on the modified resource allocation data.

FIG. 1B is a functional block diagram illustrating another example of a system 100B for project portfolio generation based on a dynamic allocation of resources. System 100B shares several aspects in common with system 100A illustrated in FIG. 1A. The description herein will focus on aspects of system 100B that may differ from system 100A. In general system 100B may perform all tasks performed by system 100A. Data processor 104 accesses resource allocation data 102, the resource allocation data 102 including a plurality of projects, a portfolio shaping preference, a plurality of constraints and a plurality of objectives, wherein the resource allocation data 102 is indicative of resources that are potentially available for allocation to the plurality of projects. Based on the resource allocation data 102, data processor 104 activates a sub-plurality of the plurality of constraints and a sub-plurality of the plurality of objectives. In one example, resource allocator 106 generates a baseline project portfolio 108B (such as the at least one project portfolio 108A of FIG. 1A) based on a first resource allocation model 106B (such as the resource allocation model 106A of FIG. 1A) based on the sub-plurality of constraints and the sub-plurality of objectives, wherein the at least one project portfolio includes a sub-plurality of the plurality of projects, and is based on a dynamic allocation of the resource allocation data. In one example, resource allocator 106 generates the baseline project portfolio 108B based on the first resource allocation model 106B by optimizing a portfolio value based on the portfolio shaping preference and the sub-plurality of objectives, while satisfying the sub-plurality of constraints. In one example, resource allocator 106 generates a second project portfolio 108C based on a second resource allocation model 106C by optimizing the portfolio value based on the portfolio shaping preference and the sub-plurality of objectives, while satisfying the sub-plurality of constraints, wherein the second project portfolio 108C also includes a second sub-plurality of the plurality of projects. Portfolio planner 110 schedules the sub-plurality of the plurality of projects, and provides the baseline project portfolio 108B and the second project portfolio 108C to the computing device via the graphical user interface.

In one example, the first resource allocation model 106B may generate the baseline project portfolio 108B by optimizing a portfolio value based on objectives under differing bounds of the sub-plurality of objectives while satisfying the sub-plurality of constraints. In one example, the second resource allocation model 106C may generate a second project portfolio 108C by optimizing the portfolio value based on a priority of objectives of the sub-plurality of objectives while satisfying the sub-plurality of constraints.

In one example, system 100B may work in tandem with system 100A. For example, referring to FIG. 1A, the portfolio planner 110 may receive an indication that the at least one project portfolio 108A is not selected. In one example, the first resource allocation model 106B (of FIG. 1B) may be the resource allocation model 106A (of FIG. 1A) and the baseline project portfolio 108E (of FIG. 1B) may be the at least one project portfolio 108A (of FIG. 1A). The resource allocator 106 may generate a second project portfolio 108C based on a second resource allocation model 106C, the second resource allocation model 106C based on the modified resource allocation data 102. In one example the portfolio planner 110 (of FIG. 1B) may provide the at least one project portfolio 108B and the second project portfolio 108C.

In one example, the portfolio planner 110 further receives one a first indication that another portfolio has been selected or a second indication that the another portfolio has not been selected, where the another portfolio is based on a comparison of the baseline project portfolio 108C and the second project portfolio 108C. In one example, the second project portfolio 108C generated by the second resource allocation model 106C may be considered as a baseline portfolio 108B that may be subsequently selected from, modified, regenerated, and so on, to yield the another portfolio for actual implementation. Of the sub-plurality of the plurality of projects, each of which may have been classified in accordance with the sub-plurality of objectives, each portfolio may include different combination of projects from the sub-plurality of the plurality of projects. In general, the first resource allocation model 106B may be used to generate the baseline project portfolio 108B by optimizing the portfolio value considering one or several objectives while satisfying the constraints. For instance, to generate the baseline portfolio 108B, the first resource allocation model 106B may consider maximizing total direct benefit under constraints 1 to 19, i.e. the first resource allocation model 106B may consider a BOM portfolio shaping preference. The second resource allocation model 106C may consider an MCRM portfolio shaping preference where three objectives in order of preference are considered, for example, maximize total direct benefit, maximize total project ranking, and maximize total project strategic alignment, with constraints 1 to 19.

The selection of a portfolio is directed at an efficient allocation of the resource allocation data. For example, suppose that the second resource allocation model 106C generates the second project portfolio 108C with same total direct benefit as the baseline project portfolio 108B, but more projects are included in the second project portfolio 108C, then the second project portfolio 108C might be considered as the baseline portfolio, i.e. it will be re-labeled as the baseline project portfolio 108B. Also, for example, suppose that after further review there is a project with high impact strategic value not included in the baseline project portfolio 108B or the second project portfolio 108C, then a new scenario (e.g., portfolio shaping preference) may be created where this project with high strategic value may be preferentially selected, i.e. the second resource allocation model 106C will generate a new second project portfolio 108C. As another example, if the second project portfolio 108C does not significantly decrease the total benefit from the baseline project portfolio 108B, then the second project portfolio 108C may be designated as a new baseline portfolio 108B, and the first resource allocation model 106B may be replaced by the second resource allocation model 106C. This process may continue until the second project portfolio 108C generated by the second resource allocation model 106C cannot further improve the baseline project portfolio 108B generated by the first resource allocation model 106B, thus ensuring the efficient allocation of the resource allocation data.

In one example, the first resource allocation model 106B and the second resource allocation model 106C may be selected from the group consisting of POM, MCRM and BOM. For example, the first resource allocation model 106B and the second resource allocation model 106C may be the POM. Also, for example, the first resource allocation model 106B and the second resource allocation model 106C may be the MCRM. As another example, the first resource allocation model 106B and the second resource allocation model 106C may be the BOM. As described herein, combinations of these models may be utilized as well. For example, the first resource allocation model 106B may be one of the POM, MCRM or BOM, and the second resource allocation model 106C may he one of the POM, MCRM or BOM, but different from the first resource allocation model 106B, thereby providing six possible choices for combinations.

Referring to FIG. 1A, the resource allocator 106 may be generally based on the BOM portfolio shaping preference. The BOM portfolio shaping preference identifies a feasible collection of portfolios, and further identifies an optimal portfolio of the feasible collection of portfolios based on a single objective of the plurality of objectives, as follows:
Z_obj=Maximize Objective
   Subject To:
      BOM constraints.
         where Z_obj is the maximum value of the objective function being optimized, subject to the BOM constraints (constraints 1 to 19). Typically, the BOM portfolio shaping preference needs a project valuation for the single objective to be optimized. In the case of the BOM portfolio shaping preference the output of the resource allocator 106 is a single optimized portfolio 108 that optimizes the single objective of the BOM portfolio shaping preference.

In one example, the BOM portfolio shaping preference maximizes the NPV of benefits derived from a selected portfolio, while satisfying the constraints. The constraints that may be considered by the resource allocation model based on the BOM portfolio shaping preference are Constraints (1) through (19), and the constraints may include project release and due date constraints, budget and labor constraints, minimum percentage of selected projects of a particular grouping or groupings of projects.

The BOM portfolio shaping preference is a single objective mixed linear-integer programming problem. Instances of the single objective that may be optimized by the BOM portfolio shaping preference follow
Total Project Ranking Maximization
Total Project Score Maximization
Total Project Benefit (direct or indirect) Maximization
Maximization total project score respect to specific Objective
   e.g. Customer Satisfaction, Strategic Alignment, Technical Alignment, Capabilities Roadmap, Employee Satisfaction, Legal/Regulatory/Audit

Arbitrary single objectives may be optimized as long as a project valuation is determined. This project valuation reflects the impact that a project has on the single objective. The BOM portfolio shaping preference constraints include the soft and hard constraints as described herein. Nonstructural constraints may be considered as soft constraints by the BOM portfolio shaping preference. That is, artificial variables may be added to the soft constraints allowing the constraints to be violated at a high penalty. In one example, the BOM portfolio shaping preference identifies a feasible collection of portfolios, and further identifies an optimal portfolio of the feasible collection of portfolios based on a single objective of the plurality of objectives.

Any inconsistencies in the BOM model may be resolved by adding artificial variables to the labor constraints and budget constraints, with appropriate penalties in the objective function, to resolve the inconsistencies.

In one example, the POM portfolio shaping preference generates the at least one project portfolio 108A based on trade-offs between conflicting objectives of the plurality of objectives. In one example, the portfolio shaping preference is the POM portfolio shaping preference that is based on a BOM model. In one example, the resource allocation model 106 generates the at least one project portfolio 108A by optimizing the portfolio value in consideration of a pair of conflicting objectives under differing bounds thereof. This pair of objectives may include a first objective and a second objective. A decision maker may be interested in a pair of conflicting objectives and may want to optimize the tradeoffs between these pair of conflicting objectives. Although a scenario with two conflicting objectives is described herein, these ideas may be easily extended to the n-conflicting objectives case, for n>2.

Accordingly, in the case of the POM portfolio shaping preference the output of the resource allocator 106 is a single at least one project portfolio 108A that optimizes the tradeoff between two objective functions under consideration, where the single at least one project portfolio 108A is the portfolio in the efficient frontier of the two objective functions under consideration at a minimum distance to an ideal portfolio. The ideal portfolio provides an optimal objective function value of the first objective function and an optimal objective function value of the second objective function. Generally, the at least one project portfolio 108A may be based on a minimal distance to optimal objective function values of n conflicting objective functions.

Generally, the POM portfolio shaping preference computes a discrete set of feasible portfolios, i.e. satisfying all the BOM constraints, in the Pareto Efficient Frontier that optimize the trade-off between the conflicting objectives. The POM portfolio shaping preference then computes an “ideal” which would correspond to an ideal portfolio that would simultaneously maximize the n objectives. The ideal portfolio corresponds to the optimal objective function values when optimizing the BOM model with respect to each of the n objectives in conflict. Note that if there is a feasible portfolio that is optimal for all n objectives, then the n objectives are not really in conflict and the ideal portfolio is an optimal portfolio for all the n objectives.

To determine a feasible portfolio that optimizes the tradeoffs between the n objectives respect to the ideal portfolio, the portfolio in the Pareto Efficient Frontier that is at a minimum distance to the ideal portfolio is identified.

The POM may be implemented via the following pseudo code, restricted to two objectives in this example:

```
Find Z1 = Max obj_1
      - Subject To:
          • BOM constraints
For i =1,0.8,0.6,0.4,0.2,0.0 Do
      - Find Z_i = Max obj_2
      - Subject To:
          • BOM constraints
          • obj_1 ≧ i*Z1
      - End For
```

The For-Loop defines the grid for the tradeoffs between obj_1 and obj_2. The granularity of this grid is a configurable parameter. Note that Z1 is the optimal objective function value respect to the objective function obj_1. Also note that Z_0.0 is the optimal objective function value respect to the objective function obj_2, we then define Z2=Z_0.0. The ideal point in the Cartesian space of the objectives where the first coordinate is defined by the values of objective function obj_1 and the second coordinate is defined by the values of objective function obj_2, is then defined as (Z1, Z2).

In one example, in solving the i^{th} optimization problem in the For-Loop, the optimal portfolio may be represented as P_i, and therefore Z_i=Max obj_2 (P_i). Also note that the objective function obj_1 evaluated at P_i is obj_1 (P_i). Therefore the points in the Cartesian space of the objectives determined by the For-Loop defines the Pareto Efficient Frontier with the optimal trade-offs of the two conflicting objectives. Each point i in the Pareto Efficient Frontier is defined as (obj_1 (P_i), Z_i), for i=1, 0.8, . . . , 0.0. The step size may be more detailed and may be configured by a user, however a more detailed POM may take longer to compute.

The portfolio in the Pareto Efficient Frontier that optimizes the trade-offs between the two conflicting objectives is the one at a minimum distance with the ideal point. The POM portfolio shaping preference may sort the portfolios in the Pareto Efficient Frontier shortest distance first and largest distance last.

In another example, the resource allocation model 106A (of FIG. 1A) may generate the at least one project portfolio 108A by optimizing the portfolio value based on a priority of objectives of the sub-plurality of objectives while satisfying the sub-plurality of constraints. The prioritized ordering of the objectives, which is referred to as a priority of the objectives, has a default ranking of the objectives that may be subsequently modified.

For example, the decision-maker may have a priority order for the set of objectives and may sort the objectives in order of preference, most important objective first. For example
Project Ranking Maximization may be the most important objective
ROI Maximization may be the 2^{nd} most important objective
Customer Satisfaction Maximization may be the 3^{rd} most important objective
Strategic Alignment Maximization may be the least important objective

In this example, the portfolio shaping preference is the MCRM based on BOMs. Generally, the MCRM portfolio shaping preference generates the at least one project portfolio 108A based on a priority of objectives of the sub-plurality of objectives while satisfying the sub-plurality of constraints. Accordingly, in the case of the MCRM portfolio shaping preference, the output of the resource allocator 106 is a single at least one project portfolio 108A that respects the hierarchy of preference of the various objective functions under consideration, optimizing one objective function at a time while respecting the optimal objective function values of more preferred objectives. The resource allocation model 106A first solves a BOM model that has the most important objective as the objective function and it considers the constraints. Then the MCRM portfolio shaping preference solves a second BOM model that has the second most important objective as the objective function. It defines the most important objective as a constraint and forces this constraint to be equal to the optimal value when solving the first BOM model, and it considers the BOM constraints.

The MCRM portfolio shaping preference continues in this fashion until it solves the last BOM model that has the least important objective as the objective function. It defines all the previous objectives as constraints and forces these constraints to be equal to the optimal value when solving the previous BOM models, and it considers the BOM constraints. These equality constraints may be relaxed and considered as inequalities and a user defined tradeoff may be considered. For example, between objective OBJ(i) and OBJ(i-1) a tradeoff of 10% might be allowed, that is when optimizing OBJ(i) we only ensure that 90% of the optimal value of OBJ(i-1) is achieved.

The MCRM considers the same constraints as the BOM. The MCRM first finds a portfolio that maximizes the most important objective. In one example, the objectives may be arbitrarily defined by the user. In a second iteration, the MCRM fixes the optimal value of the most important objective and maximizes the second most important objective. For a third iteration, the MCRM fixes the optimal values of the first most important and second most important objectives as constraints in the model, and finds a portfolio that maximizes the third most important objective. In a final iteration, the MCRM fixes the optimal value of all objectives except the least important objective as constraints in the model, and finds the at least one project portfolio 108A that maximizes the least important objective.

Note that any minimization model may be transformed into a maximization problem, so talking about maximization models does not limit the description herein.

The MCRM may be implemented via the following pseudo code:

```
• Consider n Objectives, ordered in order of importance
    - obj_1 > obj_2 ... > obj_n
• For i =1, n Do
    - Find Z_i = Max obj_i
    - Subject To:
        • BOM constraints
        • For j = 1, (i−1) Do
            - Z_j = obj_j
            - End For
    - End For
```

where Z_i and Z_i are the optimal values of the objective function obj_i and obj_j respectively.

As described herein, the selection of a portfolio is directed at an efficient allocation of the resource allocation data. In one example, if the at least one project portfolio 108A (of FIG. 1A), or one of the baseline project portfolio 108B or the second project portfolio 108C (of FIG. 1B) may be selected for actual implementation, then the process terminates. Otherwise, an iterative approach is performed, as indicated by the dashed arrows in the respective FIGS. 1A and 1B. As described herein, in one example, the resource allocator 106 may receive a modification of the portfolio shaping preference, the sub-plurality of the plurality of constraints, and the sub-plurality of the plurality of objectives. For example, at least one modification may be accessed as resource allocation data 102. The resource allocator 106 may regenerate the at least one project portfolio 108A based on the modification. For example, the at least one project portfolio 108A (of FIG. 1A) may be regenerated using the resource allocation model 106A (of FIG. 1A). In one example, the second project portfolio 108C (of FIG. 1B) may be regenerated using the second resource allocation model 106C (of FIG. 1B). The steps may be repeated until at least one project portfolio has been selected for actual implementation.

Accordingly, the decision maker may perform sensitivity analysis for the portfolios based on such an iterative process. Sensitivity analysis may also be performed, for example, when forcing inclusion (or exclusion) of a project and checking its impact with respect to the various objectives and Key Performance Indicators (“KPI”). In one example, during sensitivity analysis, the decision maker may create inconsistencies with the resources available (budgets and/or FTE). System 100A may detect such inconsistencies, and may correct the budget and/or FTE available in order to satisfy the decision maker preferences during the sensitivity analysis.

In one example, the portfolio planner 110 of system 100A and/or system 100B selects or removes a project of the sub-plurality of projects included in the at least one project portfolio 108A, and provides project data for the selected or removed project. In one example, the project data may include at least one of a project identifier, a project name, a start date, and a finish date. In one example, the portfolio planner 110 may generate an output table indicating which projects have been selected and the start time of each selected project. The output table may contain the following fields: Project ID, Project Name, Start Date, and Finish Date. In one example, the portfolio planner 110 may generate at least one report based on the output table, where the reports analyze the efficient allocation of the resource allocation data. In one example, the portfolio planner 110 of system 100A and/or system 100B schedules the sub-plurality of projects included in the at least one project portfolio 108A. In one example, the portfolio planner 110 may schedule the sub-plurality of projects based on the output table.

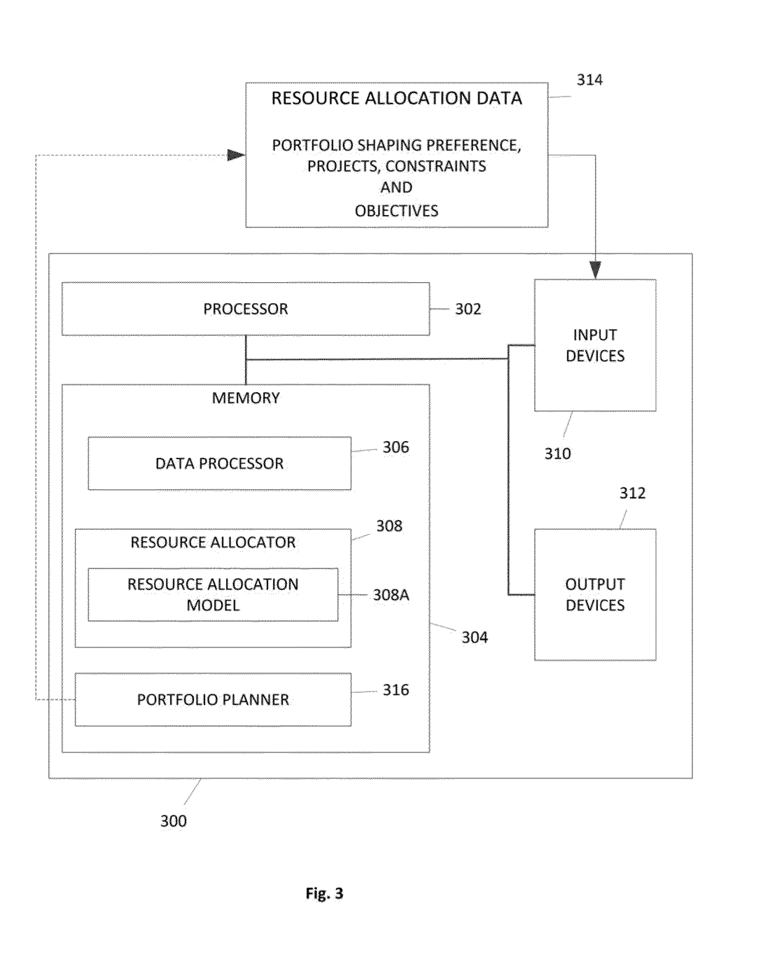

FIG. 3 is a block diagram illustrating one example of a processing system 300 for implementing the system 100A for project portfolio generation based on a dynamic allocation of resources. Processing system 300 includes a processor 302, a memory 304, input devices 310, and output devices 312. Processor 302, memory 304, input devices 310, and output devices 312 are coupled to each other through communication link (e.g., a bus).

Processor 302 includes a Central Processing Unit (CPU) or another suitable processor. In one example, memory 304 stores machine readable instructions executed by processor 302 for operating processing system 300. Memory 304 includes any suitable combination of volatile and/or non-volatile memory, such as combinations of Random Access Memory (RAM), Read-Only Memory (ROM), flash memory, and/or other suitable memory. In one example, resource allocation data 314 may be accessed via input devices 310, and the at least one project portfolio may be provided by output devices 312. In one example, modified resource allocation data may be accessed via input devices 310. In one example, the at least one project portfolio and the second portfolio may be provided via the output devices 312.

Memory 304 stores instructions to be executed by processor 302 including instructions for a data processor 306, a resource allocator 308, and a portfolio planner 316.

In one example, processor 302 executes instructions of data processor 306 to receive resource allocation data 314, the resource allocation data 314 including a plurality of projects, a portfolio shaping preference, a plurality of constraints and a plurality of objectives, wherein the resource allocation data is indicative of resources that are potentially available for allocation to the plurality of projects. In one example, the resource allocation data 314 includes structural data and configurable data In one example, the plurality of constraints includes a soft constraint that may be violated. In one example, the plurality of constraints includes a hard constraint that may not be violated. In one example, the plurality of constraints includes a time-phased resource constraint, and a time-phased budget constraint. In one example, the plurality of objectives includes at least one of a return of investment function, objective function, project score, project ranking, and project benefit. In one example, an objective of the plurality of objectives may be associated with an objective score indicative of relevance of a project to the objective. In one example, the portfolio shaping preference may be selected from the group consisting of a POM portfolio shaping preference, a MCRM portfolio shaping preference, and a BOM portfolio shaping preference.

In one example, processor 302 executes instructions of data processor 306 to activate, based on the portfolio shaping preference in the resource allocation data 314, a sub-plurality of the plurality of constraints and a sub-plurality of the plurality of objectives. In one example, processor 302 executes instructions of data processor 306 to load the resource allocation data 314 into an appropriate portfolio resource allocation model. For example, if the portfolio shaping preference is the BOM, then an appropriate single objective and relevant constraints may be loaded into a structured dataset that may be utilized by the resource allocation model applicable for the BOM.

Processor 302 also executes instructions of the resource allocator 308 to generate at least one project portfolio. In one example, processor 302 executes instructions of the resource allocation model 308A included in the resource allocator 308 to generate the at least one project portfolio based on the sub-plurality of constraints and the sub-plurality of objectives, wherein the at least one project portfolio includes a sub-plurality of the plurality of projects, and is based on a dynamic allocation of the resource allocation data. In one example, processor 302 executes instructions of the resource allocation model 308A included in the resource allocator 308 to generate the at least one project portfolio by optimizing a portfolio value based on the portfolio shaping preference and the sub-plurality of objectives, while satisfying the sub-plurality of constraints. In one example, memory 304 may store the at least one project portfolio.

In one example, processor 302 executes instructions of a portfolio planner 316 to schedule the sub-plurality of the plurality of projects, and provide the at least one project portfolio to a computing device via a graphical user interface. In one example, processor 302 executes instructions of the portfolio planner 316 to receive an indication that the at least one project portfolio is not selected. In one example, processor 302 executes instructions of a portfolio planner 316 to prompt the data processor 306 to access modified resource allocation data.

In one example, processor 302 executes instructions of the portfolio planner 316 to prompt the resource allocator 308 to generate a second project portfolio based on the modified resource allocation data. For example, processor 302 executes instructions of the resource allocator 308 to generate at least one project portfolio based on a first resource allocation model by optimizing a portfolio value based on the portfolio shaping preference and the sub-plurality of objectives, while satisfying the sub-plurality of constraints, wherein the at least one project portfolio includes a sub-plurality of a plurality of projects. In one example, processor 302 executes instructions of the resource allocator 308 to generate a second project portfolio based on a second resource allocation model by optimizing the portfolio value based on the portfolio shaping preference and the sub-plurality of objectives, while satisfying the sub-plurality of constraints, wherein the at least one project portfolio includes a sub-plurality of a plurality of projects.

In one example, processor 302 executes instructions of the portfolio planner 316 to provide the at least one project portfolio and the second project portfolio, and to receive one of a first indication that the at least one project portfolio is selected or the second project portfolio is selected, or a second indication that neither of the at least one project portfolio or the second project portfolio is selected. In one example, the first resource allocation model may be the resource allocation model 308A and the baseline project portfolio may be the at least one project portfolio. The resource allocator 308 may generate a second project portfolio based on the second resource allocation model, the second resource allocation model based on the modification of the resource allocation data 314. In one example, the portfolio planner 316 may provide the at least one project portfolio and the second project portfolio via the graphical user interface.

In one example, the at least one project portfolio generated by the first resource allocation model may be considered as a baseline portfolio that may be subsequently selected from, modified, regenerated, and so on, to yield a desired portfolio for actual implementation. Of the sub-plurality of the plurality of projects, each of which may have been classified in accordance with the sub-plurality of objectives, each portfolio may include different combination of projects from the sub-plurality of the plurality of projects. In general, the first resource allocation model may be used to generate the at least one project portfolio by optimizing the portfolio value considering one or several objectives while satisfying the constraints.

In one example, if the at least one project portfolio, or one of the at least one project portfolio or the second project portfolio is selected for actual implementation, then the process terminates. Otherwise, an iterative approach is performed, as indicated by the dashed arrow in FIG. 3. As described herein, in one example, the resource allocator 308 may receive a modification of the portfolio shaping preference, the sub-plurality of the plurality of constraints, and the sub-plurality of the plurality of objectives. For example, at least one modification may be accessed as resource allocation data 314 via input devices 310. In one example, processor 302 executes instructions of the data processor 306 to receive a modification of the portfolio shaping preference to be used (BOM. MCRM, or POM), the sub-plurality of the plurality of constraints, and the sub-plurality of the plurality of objectives. In one example, processor 302 executes instructions of the resource allocator 308 to regenerate a new portfolio based on the modification. Processor 302 executes instructions of the resource allocator 308 to regenerate at least one project portfolio based on the modification. For example, the at least one project portfolio may be regenerated using the resource allocation model 308A based on another project portfolio shaping preference. In one example, the second project portfolio may be regenerated using the second resource allocation model based on a second portfolio shaping preference. The steps may be repeated until at least one project portfolio has been selected for actual implementation.

In one example, the first portfolio shaping preference and the second portfolio shaping preference may be selected from the group consisting of POM, MCRM and BOM. For example, the first and second portfolio shaping preferences may be the POM. Also, for example, the first and second portfolio shaping preferences may be the MCRM. As another example, the first and second portfolio shaping preferences may be the BOM. As described herein, combinations of these portfolio shaping preferences may be utilized as well. For example, the first portfolio shaping preference may be one of the POM, MCRM or BOM, and the second portfolio shaping preference may be one of the POM, MCRM or BOM, but different from the first portfolio shaping preference, thereby providing six possible choices for combinations.

In one example, processor 302 executes instructions of the portfolio planner 316 to select or remove a project of the sub-plurality of projects included in the at least one project portfolio, and provide project data for the selected or removed project. In one example, the project data may include at least one of a project identifier, a project name, a start date, and a finish date. In one example, the portfolio planner 316 may generate an output table indicating which projects have been selected and the start time of each selected project.

In one example, processor 302 executes instructions of the portfolio planner 316 to schedule the sub-plurality of projects included in the at least one project portfolio. In one example, the portfolio planner 316 may schedule the sub-plurality of projects based on the output table.

Input devices 310 include a keyboard, mouse, data ports, and/or other suitable devices for inputting information into processing system 300. In one example, input devices 310 are used to access resource allocation data 314, including modified projects, portfolio shaping preferences, constraints and objectives. Output devices 312 include a monitor, speakers, data ports, and/or other suitable devices for outputting information from processing system 300. In one example, output devices 312 are used to output the at least one project portfolio, and/or the second portfolio.

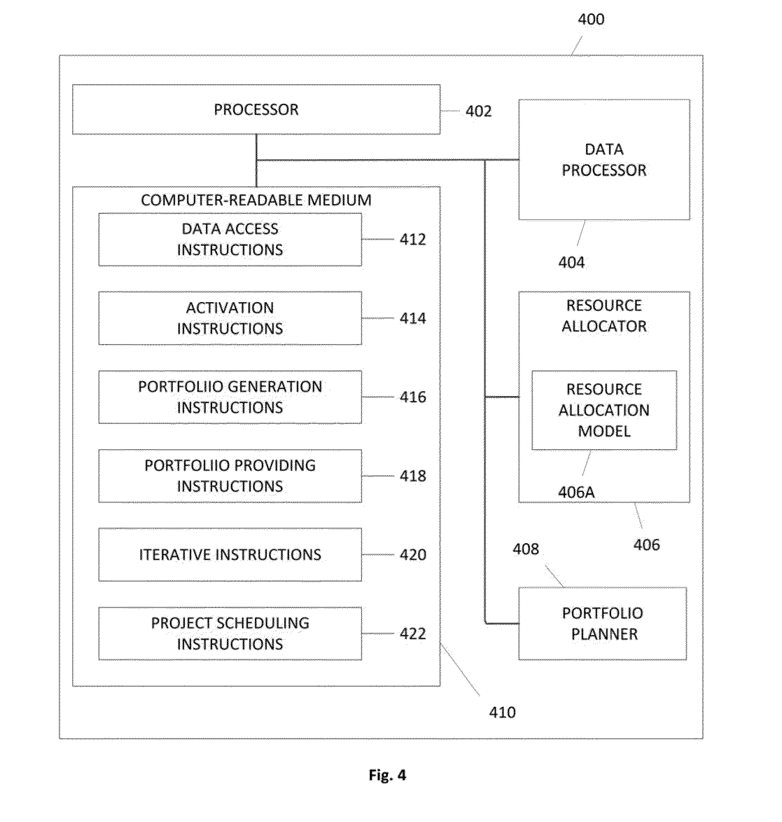

FIG. 4 is a block diagram illustrating one example of a computer readable medium for project portfolio generation based on a dynamic allocation of resources. Processing system 400 includes a processor 402, a computer readable medium 410, a data processor 404, a resource allocator 406, and a portfolio planner 408. In one example, the resource allocator 406 includes a resource allocation model 406k Processor 402, computer readable medium 410, the data processor 404, the resource allocator 406, and the portfolio planner 408 are coupled to each other through communication link (e.g., a bus).

Processor 402 executes instructions included in the computer readable medium 410. Computer readable medium 410 includes data access instructions 412 of the data processor 404 to receive resource allocation data, the resource allocation data including a plurality of projects, a portfolio shaping preference, a plurality of constraints and a plurality of objectives, wherein the resource allocation data is indicative of resources that are potentially available for allocation to the plurality of projects. Computer readable medium 410 includes activation instructions 414 of the data processor 404 to activate, based on the portfolio shaping preference, a sub-plurality of the plurality of constraints and a sub-plurality of the plurality of objectives.

Computer readable medium 410 includes portfolio generation instructions 416 of resource allocator 406 to generate at least one project portfolio. In one example, computer readable medium 410 includes portfolio generation instructions 416 of the resource allocation model 406A to generate the at least one project portfolio based on the sub-plurality of constraints and the sub-plurality of objectives, wherein the at least one project portfolio includes a sub-plurality of the plurality of projects, and is based on a dynamic allocation of the resource allocation data. In one example, computer readable medium 410 includes portfolio generation instructions 416 of the resource allocation model 406A to generate the at least one project portfolio by optimizing a portfolio value based on the portfolio shaping preference and the sub-plurality of objectives, while satisfying the sub-plurality of constraints.

As described herein, in one example of the iterative portfolio optimization process, a first portfolio shaping preference and a second portfolio shaping preference may be selected from the group consisting of POM, MCRM and BOM. For example, the first and second portfolio shaping preferences may be the POM. Also, for example, the first and second portfolio shaping preferences may be the MCRM. As another example, the first and second portfolio shaping preferences may be the BOM. As described herein, combinations of these portfolio shaping preferences may be utilized as well. For example, the first portfolio shaping preference may be one of the POM, MCRM or BOM, and the second portfolio shaping preference may be one of the POM, MCRM or BOM, but different from the first portfolio shaping preference, thereby providing six possible choices for combinations.

Computer readable medium 410 includes portfolio providing instructions 418 of the portfolio planner 418 to provide the at least one project portfolio to a computing device via a graphical user interface.

Computer readable medium 410 includes iterative instructions 420 of the data processor 404, the resource allocator 406, and portfolio planner 418 to execute the instructions to receive, activate, generate, and provide, until a project portfolio is selected.

Computer readable medium 410 includes project scheduling instructions 422 of the portfolio planner 418 to schedule the sub-plurality of projects included in the selected project portfolio.

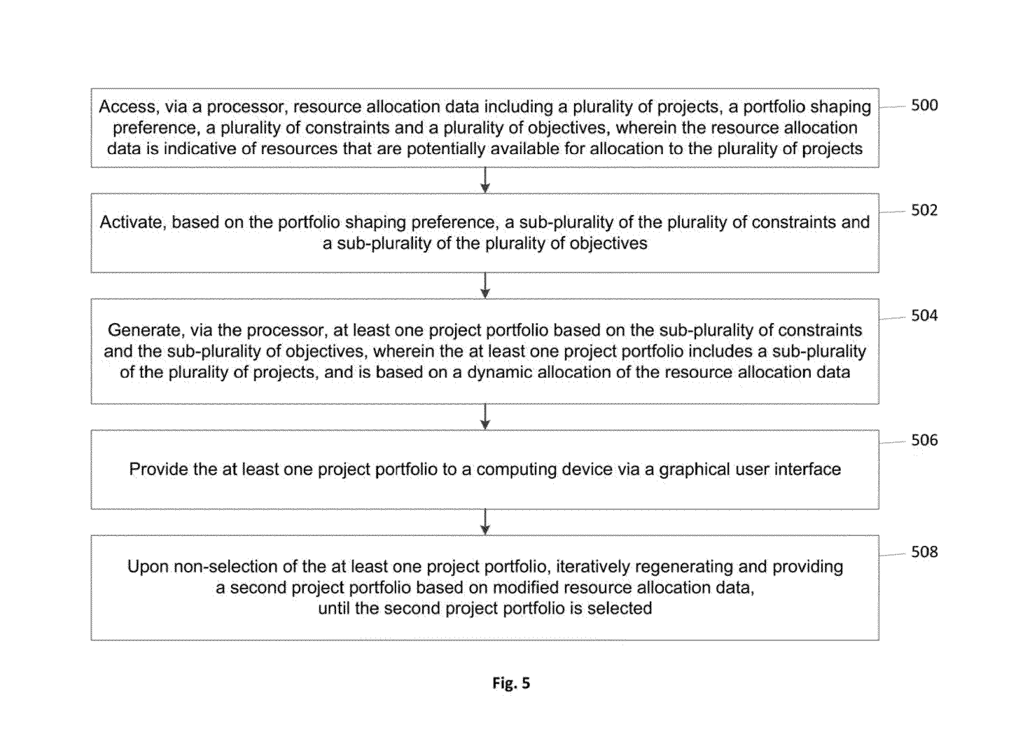

FIG. 5 is a flow diagram illustrating one example of a method for project portfolio generation based on a dynamic allocation of resources. At 500, resource allocation data is accessed via a processor, the resource allocation data including a plurality of projects, a portfolio shaping preference, a plurality of constraints and a plurality of objectives, wherein the resource allocation data is indicative of resources that are potentially available for allocation to the plurality of projects. At 502, based on the portfolio shaping preference, a sub-plurality of the plurality of constraints and a sub-plurality of the plurality of objectives are activated. At 504, at least one project portfolio is generated based on the sub-plurality of constraints and the sub-plurality of objectives, where the at least one project portfolio includes a sub-plurality of the plurality of projects, and is based on a dynamic allocation of the resource allocation data.

At 506, the at least one project portfolio is provided to a computing device via a graphical user interface. At 508, upon non-selection of the at least one project portfolio, a second project portfolio based on modified resource allocation data is iteratively regenerated and provided, until the second project portfolio is selected.

As described herein, in one example of the iterative portfolio optimization process, a first portfolio shaping preference and a second portfolio shaping preference may be selected from the group consisting of POM, MCRM and BOM. For example, the first and second portfolio shaping preferences may be the POM. Also, for example, the first and second portfolio shaping preferences may be the MCRM. As another example, the first and second portfolio shaping preferences may be the BOM. As described herein, combinations of these portfolio shaping preferences may be utilized as welt For example, the first portfolio shaping preference may be one of the POM, MCRM or BOM, and the second portfolio shaping preference may be one of the POM, MCRM or BOM, but different from the first portfolio shaping preference, thereby providing six possible choices for combinations.

In one example, the iteratively regenerating and providing the second project portfolio includes providing the at least one project portfolio and the second project portfolio, and receiving an indication that one of the at least one project portfolio and the second project portfolio is selected.

In one example, the iteratively regenerating and providing a second project portfolio includes designating the at least one project portfolio as a baseline project portfolio, generating a second project portfolio based on a second portfolio shaping preference, the second portfolio shaping preference based on the modified resource allocation data, and providing the baseline project portfolio and the second project portfolio. In one example, the method further includes receiving, via the graphical user interface, one of a first indication that another project portfolio is selected or a second indication that the another project portfolio is not selected, where the another project portfolio is based on a comparison of the baseline project portfolio and the second project portfolio.

In one example, the method further includes selecting or removing a project of the sub-plurality of projects included in the at least one project portfolio, and providing project data for the selected or removed project. In one example, the project data includes at least one of a project identifier, a project name, a start date, and a finish date.

In one example, the method further includes scheduling the sub-plurality of the plurality of projects included in the at least one project portfolio. In one example, the method further includes scheduling the sub-plurality of the plurality of projects included in the a second project portfolio

In one example, the portfolio shaping preference includes at least one of a Pareto optimization model (“POM”) portfolio shaping preference, a multiple-criteria ranking optimization model (“MCRM”) portfolio shaping preference and a basic optimization model (“BOM”) portfolio shaping preference.

In one example, the resource allocation data includes structural data and configurable data.

In one example, the plurality of constraints includes at least one of a soft constraint that may be violated, and a hard constraint that may not be violated. In one example, the plurality of constraints includes the soft constraint, and the method further includes detecting an infeasibility of the soft constraint. In one example, the method further includes correcting the detected infeasibility of the soft constraint. In one example, the method further includes providing a modified constraint that corrects the detected infeasibility of the soft constraint

In one example, a budget shortage may be detected. In one example, the budget shortage may be corrected. In one example, a FTE capacity shortage may be detected. In one example, the FTE capacity shortage may be corrected.

In one example, the plurality of constraints includes a time-phased resource constraint, and a time-phased budget constraint. In one example, the time-phased budget constraint is different from a time period scale in a planning horizon.

In one example, the plurality of objectives includes at least one of a return of investment function, objective function, project score, project ranking, and project benefit. In one example, the objective function may be associated with an objective score indicative of relevance of a project to the objective.

In one example, the plurality of objectives includes any measurable objective function.

In one example, the project value of a project in a portfolio may be defined before, during, and/or after completion of the project.

Examples of the disclosure provide a generalized system for project portfolio generation based on a dynamic allocation of resources. The systems and methods described herein allow multi-objective optimization of a project portfolio with time-phased resource constraints, such as labor constraints (e.g., differentiated by role and capabilities), and budget constraints (e.g., differentiated by various type of costs such as labor IT costs, non-labor IT costs, business costs, and so forth). The systems and methods described herein enable optimization of any objective as long the project valuation respect to the objective is defined.

The systems and methods described herein provide flexibility in project portfolio generation based on a dynamic allocation of resources, including, for example, enabling varying budget constraints based on arbitrary decision maker defined budgeting period; addressing trade-offs between two conflicting objectives of the plurality of objectives while considering resources capacity limits; enabling project value to be defined not only at the period of the completion of the project but also at periods before and after completion of the project; enabling simultaneous optimization of the selection and the scheduling of a project portfolio; allowing the decision maker to specify windows of opportunity where a project may start and complete; allowing the decision maker to perform sensitivity analysis; allowing the decision maker to fix the start time of a project when selected: allowing shaping of a portfolio with decision maker defined upper and lower bounds on the percentage; allowing for a scenario wherein all projects in a Program of related projects are selected or none are selected; allowing for Project Temporal Constraints to ensure that a set of related projects follow minimum time lags or precedence relations if selected; and enabling real time re-scheduling decision making due to the fast response time of finding an optimal portfolio. The systems and methods described herein may automate lengthy and cumbersome manual processes, for example, based on spreadsheet analyses.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a data processor to:
access resource allocation data including a plurality of projects, a portfolio shaping preference, a plurality of constraints and a plurality of objectives, wherein the resource allocation data is indicative of resources that are potentially available for allocation to the plurality of projects, and
activate, based on the portfolio shaping preference, a sub-plurality of the plurality of constraints and a sub-plurality of the plurality of objectives;
a resource allocator to generate at least one project portfolio based on the sub-plurality of constraints and the sub-plurality of objectives, wherein the at least one project portfolio includes a sub-plurality of the plurality of projects, and is based on a dynamic allocation of the resource allocation data; and
a portfolio planner to:
schedule the sub-plurality of the plurality of projects, and
provide the at least one project portfolio to a computing device via a graphical user interface.

2. The system of claim 1, wherein:
the portfolio planner receives an indication, via the graphical user interface, that the at least one project portfolio is not selected;
the data processor accesses modified resource allocation data; and
the resource allocator generates a second project portfolio based on the modified resource allocation data.

3. The system of claim 1, wherein the portfolio planner further selects or removes a project of the sub-plurality of projects, and provides project data for the selected or removed project.

4. The system of claim 1, wherein the resource allocator generates the at least one project portfolio based on a portfolio value based on differing bounds of the sub-plurality of objectives while satisfying the sub-plurality of constraints.

5. The system of claim 4, wherein the project value may be defined before, during, and/or after completion of the project.

6. The system of claim 1, wherein the resource allocator generates the at least one project portfolio based on a priority of objectives of the sub-plurality of objectives while satisfying the sub-plurality of constraints.

7. The system of claim 1, wherein the portfolio shaping preference includes at least one of a basic optimization model, a Pareto optimization model, and a multiple criteria ranking optimization model.

8. The system of claim 7, wherein the Pareto optimization model generates the at least one project portfolio based on trade-offs between conflicting objectives of the plurality of objectives.

9. The system of claim 1, wherein the plurality of constraints includes a soft constraint, and the resource allocator further:
detects an infeasibility of the soft constraint; and
provides a modified constraint that corrects the detected infeasibility of the soft constraint.

10. A method for project resource allocation, the method comprising:
accessing, via a processor, resource allocation data including a plurality of projects, a portfolio shaping preference, a plurality of constraints and a plurality of objectives, wherein the resource allocation data is indicative of resources that are potentially available for allocation to the plurality of projects;
activating, based on the portfolio shaping preference, a sub-plurality of the plurality of constraints and a sub-plurality of the plurality of objectives;
generating, via the processor, at least one project portfolio based on the sub-plurality of constraints and the sub-plurality of objectives, wherein the at least one project portfolio includes a sub-plurality of the plurality of projects, and is based on a dynamic allocation of the resource allocation data;
providing the at least one project portfolio to a computing device via a graphical user interface; and
upon non-selection of the at least one project portfolio, iteratively regenerating and providing a second project portfolio based on modified resource allocation data, until the a second project portfolio is selected.

11. The method of claim 10, wherein the iteratively regenerating and providing the second project portfolio includes providing the at least one project portfolio and the second project portfolio, and receiving an indication that one of the at least one project portfolio and the second project portfolio is selected.

12. The method of claim 10, further including scheduling the sub-plurality of the plurality of projects.

13. The method of claim 10, wherein the portfolio shaping preference includes at least one of a basic optimization model, a Pareto optimization model, and a multiple criteria ranking optimization model.

14. The method of claim 10, wherein the plurality of constraints includes a soft constraint, and further comprising:
detecting an infeasibility of the soft constraint; and
providing a modified constraint that corrects the detected infeasibility of the soft constraint.

15. A non-transitory computer readable medium comprising executable instructions to:
access, via a processor, resource allocation data including a plurality of projects, a portfolio shaping preference, a plurality of constraints and a plurality of objectives, wherein the resource allocation data is indicative of resources that are potentially available for allocation to the plurality of projects;
activate, based on the portfolio shaping preference, a sub-plurality of the plurality of constraints and a sub-plurality of the plurality of objectives;
generate, via the processor, at least one project portfolio based on the sub-plurality of constraints and the sub-plurality of objectives, wherein the at least one project portfolio includes a sub-plurality of the plurality of projects, and is based on a dynamic allocation of the resource allocation data;
provide the at least one project portfolio to a computing device via a graphical user interface;
iteratively execute the instructions to receive, activate, generate, and provide, until a project portfolio is selected; and
schedule the sub-plurality of the plurality of projects in the selected project portfolio.
